(19) United States
(12) Patent Application Publication
(10) Pub. No.: US 2026/0274621 A1
(43) Pub. Date: Sep. 17, 2026

(54) TELESCOPING BOOM ASSEMBLY

(71) Applicant: DEERE & COMPANY, MOLINE, IL (US)

(72) Inventor: PEKKA VIHTORI VESANEN, Tampere (FI)

(21) Appl. No.: 19/567,496

(22) Filed: Mar. 16, 2026

(30) Foreign Application Priority Data
Mar. 17, 2025 (EP) 25164116.3

(51) Int. Cl. B66C 23/70; B60P 1/54; B66C 1/68; B66C 23/42

(52) U.S. Cl. CPC B66C 23/701; B60P 1/5433; B66C 1/68; B66C 23/42

(57) ABSTRACT

A telescoping boom assembly for use with a vehicle comprises an outer tube, a central tube slidably disposed within the outer tube, an inner tube slidably disposed within the central tube, a linear actuator, and a coupling mechanism. The linear actuator has a housing coupled to the proximal end of the outer tube and positioned between the central tube and the inner tube. The linear actuator further has a movable output element coupled to a distal end of the central tube and configured to move the central tube relative to the outer tube. The coupling mechanism operatively connects the central tube to the inner tube and is configured to move the inner tube relative to the central tube in response to movement of the central tube relative to the outer tube.

### CROSS REFERENCE TO RELATED APPLICATIONS

This application claims priority under 35 U.S.C. § 119 to European patent application EP 25164116.3, filed on 17 Mar. 2025, the disclosure of which is incorporated herein by reference.

### FIELD OF THE DISCLOSURE

The present disclosure generally relates to a telescoping boom assembly.

### BACKGROUND

Telescoping boom assemblies, also referred to as jibs, are used to mount a tool to a vehicle such that the tool is linearly movable relative to the vehicle. Such assemblies are commonly employed on forestry machines. By way of example, the tool may comprise a harvester head of a tree harvester or a grapple of a forwarder. The telescoping boom assembly is typically mounted at an outer end of a crane arrangement having multiple degrees of freedom, including rotation about a vertical axis and articulation about a horizontal axis (see, e.g., SE 546 161 C2 and US 2019/0315604 A1, which do not describe details of the boom assembly).

One example of a telescoping boom assembly is described in U.S. Pat. No. 3,809,249 A. The described boom assembly includes an outer tube, a central tube, and an inner tube, each having a proximal end and a distal end. The tubes have generally rectangular cross sections and are arranged such that, in a retracted position, the inner tube is disposed within the central tube and the central tube is disposed within the outer tube. A linear actuator, implemented as a double-acting hydraulic cylinder, has a housing coupled to the proximal end of the outer tube and a rod end coupled to a fourth tube arranged within the inner tube. The actuator directly drives movement of the fourth tube and the central tube. Movement of the central tube is transmitted to the inner tube by a chain mechanism such that the inner tube moves relative to the central tube by the same distance as the central tube moves relative to the outer tube, resulting in the distal end of the inner tube moving twice the distance of the rod end of the actuator. Except for an end portion of the chain mechanism and a conduit extending to a tool at the distal end, the boom assembly is contained within the outer tube.

US 2003/0205547 A1 describes another telescoping boom assembly in which a linear actuator is arranged within a central tube, with a rod end coupled to a proximal end of an outer tube. An inner tube and a further innermost tube are coupled to the central tube by chain mechanisms and, in a retracted position, surround the linear actuator.

DE 10 2012 001 184 B1 describes a further telescoping boom assembly including an outer tube, a central tube, and an inner tube. In this arrangement, a linear actuator is arranged outside the outer tube and transmits motion to the central tube and the inner tube via separate chain or rope mechanisms, such that movement of the actuator is separately conveyed to each tube.

In certain operating environments, such as forestry applications, it may be desirable for a linear actuator to be arranged within an outer tube of a telescoping boom assembly, where the actuator is positioned in a relatively protected location. Arrangements in which a linear actuator is located outside the outer tube may be more susceptible to damage from external obstacles, such as trees or branches.

However, positioning a linear actuator within a telescoping boom assembly such that the actuator is surrounded by an inner tube in a retracted position may require a separate mechanical drive connection between the actuator and a central tube, as described, for example, in U.S. Pat. No. 3,809,249 A. In other described arrangements, such as US 2003/0205547 A1, a housing of the linear actuator is fixed to a central tube while a rod of the actuator is coupled to a proximal end of an outer tube, which may necessitate internal passageways for hydraulic fluid within the actuator rod. Such configurations may limit the ability to employ linear actuators having integrated position sensing, which typically require sufficient internal space within the rod for position sensing components (see, e.g., DE 197 47 949 A1).

Therein lies an opportunity for improvement by overcoming or at least mitigating one or more of the foregoing considerations.

### SUMMARY OF THE DISCLOSURE

The present disclosure comprises a harvester with a crane, a harvester

### BRIEF DESCRIPTION OF THE DRAWINGS

FIG. 1 is a front perspective view of an off-road vehicle, illustrated as a forwarder, having a crane with a telescoping boom assembly arranged at an outer end thereof;

FIG. 2 is a side sectional view of the telescoping boom assembly in a retracted position of the vehicle of FIG. 1;

FIG. 3 is a vertical sectional view of the telescoping boom assembly in an extended position of the vehicle of FIG. 1;

FIG. 4 is a cross-sectional view of the telescoping boom assembly taken along line 4-4 of FIG. 2;

FIG. 5 is a perspective side cross-sectional view of a distal end of the telescoping boom assembly in the retracted position;

FIG. 6 is a perspective side cross-sectional view of a proximal end of the telescoping boom assembly in the retracted position; and

FIG. 7 is a perspective view of a sledge and a support element configured to support an inner tube relative to a central tube of the telescoping boom assembly.

Before any embodiments are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Further embodiments may include any combination of features from one or more dependent claims, and such features may be incorporated, collectively or separately, into any independent claims.

### DETAILED DESCRIPTION

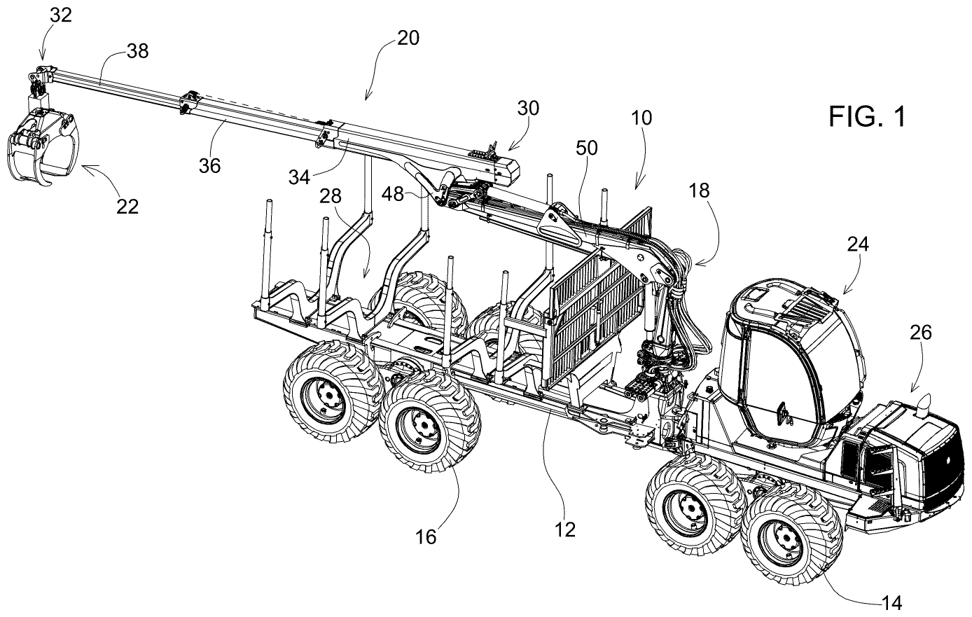

FIG. 1 illustrates an off-road vehicle 10. The off-road vehicle 10 includes an articulated chassis 12 supported on ground-engaging members in the form of driven front wheels 14 and rear wheels 16. The chassis 12 supports a crane 18, at an outer end of which a proximal end 30 of a telescoping boom assembly 20 is mounted. A tool 22, illustrated as a grapple, is mounted at a distal end 32 of the telescoping boom assembly 20. The chassis 12 further supports an operator cab 24 and an engine compartment 26 housing an engine configured to provide mechanical, electrical, and/or hydraulic power to driven components of the vehicle 10. Vehicle 10, shown here as a forwarder, has a load space 28 for receiving tree trunks collected by the tool 22. The crane 18 is rotatable relative to the chassis 12 about a generally vertical axis located in a region of articulation of the chassis 12 and includes an upper part 50 having an adjustable inclination and supporting the proximal end 30 of the telescoping boom assembly 20 at an outer end thereof.

In other embodiments, the telescoping boom assembly 20 may be used on other forestry vehicles, such as harvesters, or on other vehicles including telescopic loaders or vehicles having liftable platforms, for example for servicing street lighting.

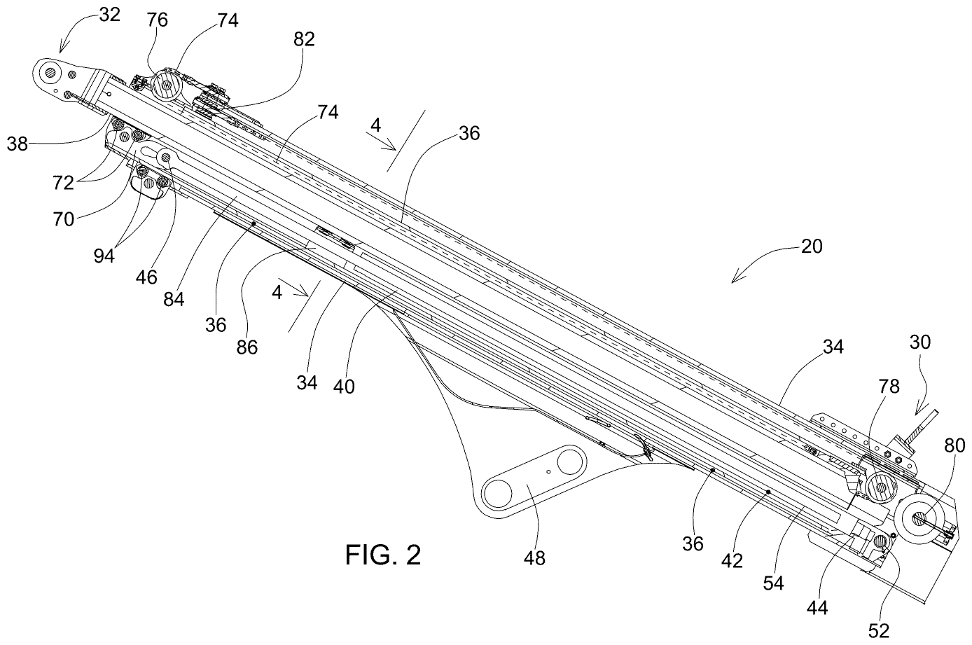

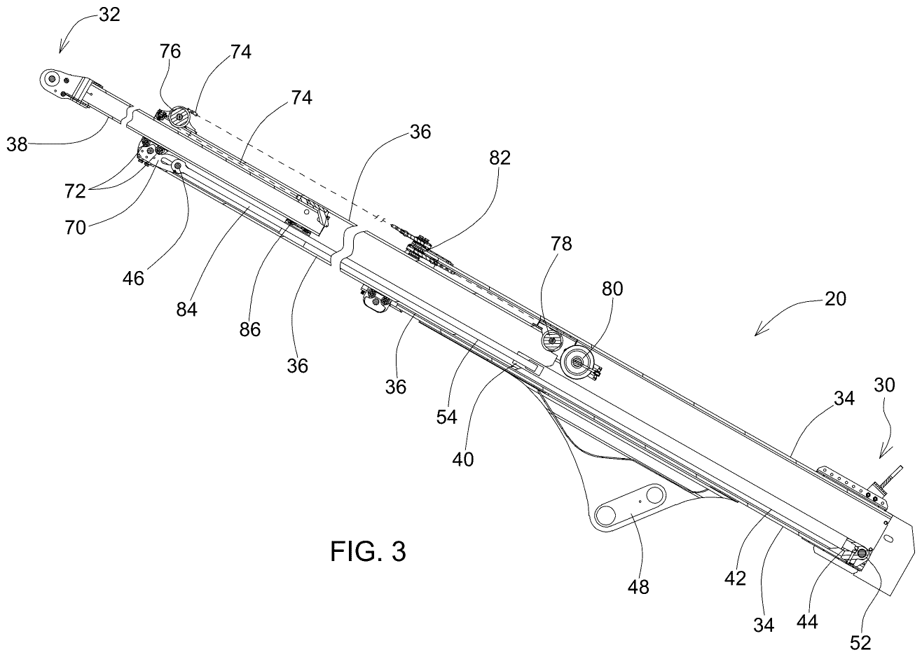

The telescoping boom assembly 20 includes an outer tube 34, a central tube 36, and an inner tube 38, which are movable by a linear actuator 40 between a retracted position, as shown in FIG. 2, and an extended position, as shown in FIGS. 1 through 3, as well as intermediate positions therebetween. The outer tube 34 surrounds the central tube 36, which in turn surrounds the inner tube 38. In the retracted position, the distal end 32 of the boom assembly 20 corresponds to the distal ends of the tubes 34, 36, and 38, and the proximal end 30 corresponds to the proximal ends of the tubes 34, 36, and 38.

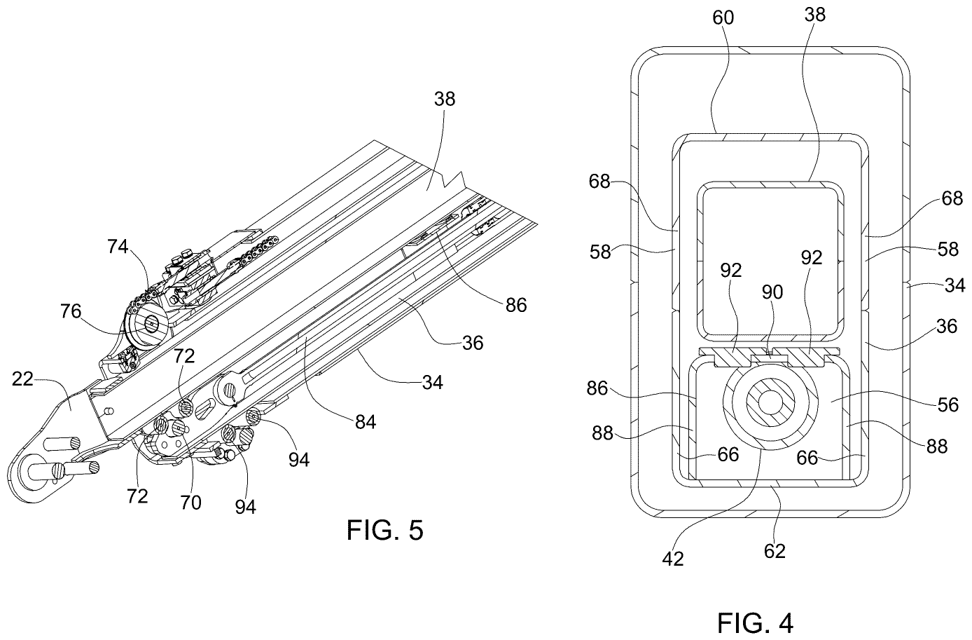

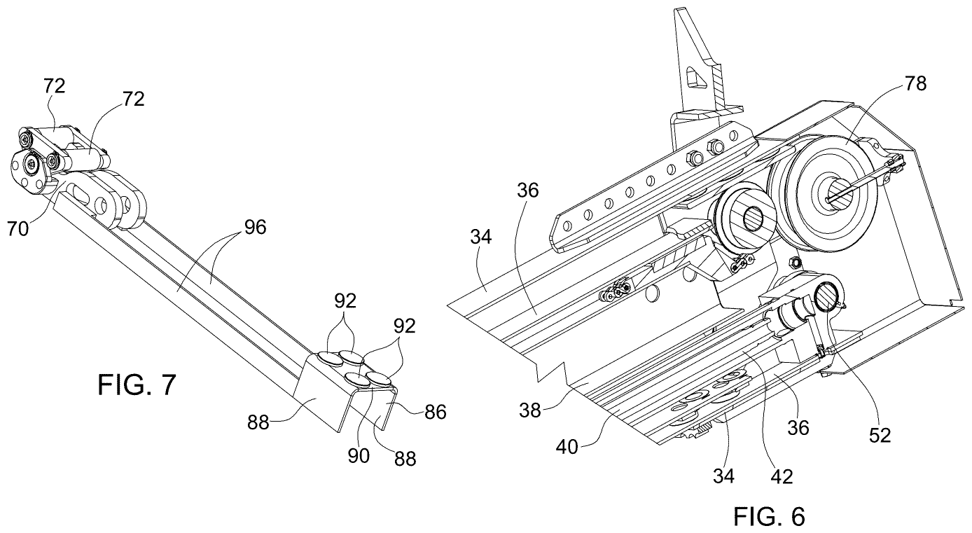

Reference is now made to FIGS. 2 through 7. The outer tube 34 is connected to a flange 48 for mounting the outer tube 34 to the outer end of the upper part 50 of the crane 18. The central tube 36 is arranged within the outer tube 34 for telescoping movement driven by the linear actuator 40. In the illustrated embodiment, the linear actuator 40 is a double-acting hydraulic cylinder having a housing 42 with a proximal end 44 connected to the outer tube 34 by a pivot pin 52 defining an axis extending transverse to a direction of extension and retraction of the telescoping boom assembly 20. The pivot pin 52 may be supported in side walls of the outer tube 34, mounted on a bracket fixed to the outer tube 34, or connected in another suitable manner. As a result, a mechanical connection and force transfer location between the housing 42 and the outer tube 34 is located in the vicinity of their respective proximal ends. During operation, the housing 42 remains fixed relative to the outer tube 34, except for minor pivoting movement about the pivot pin 52 due to mechanical tolerances.

The housing 42 contains a piston 54 having a rod 84 forming an output element of the linear actuator 40. A distal end of the rod 84 is connected to the central tube 36 by a pivot pin 46 defining an axis transverse to the extension direction of the boom assembly 20. The pivot pin 46 is supported on a support a sledge 70 that slides along an upper interior surface of the outer tube 34 and supports a distal end of the central tube 36 on rollers 72. Accordingly, a mechanical connection and force transfer location between the rod 84 and the central tube 36 is located in the vicinity of their respective distal ends.

The central tube 36 includes vertical side walls 58, a horizontal top wall 60, and a horizontal bottom wall 62. The linear actuator 40 is arranged within an interior space 56 of the central tube 36, laterally between the side walls 58 and vertically between the bottom wall 62 of the central tube 36 and a bottom wall of the inner tube 38. The inner tube 38 is thus surrounded by upper portions 68 of the side walls 58, the top wall 60, and, on an underside, by the linear actuator 40.

To support the inner tube 38 relative to the central tube 36, a support element 86 is fixed to the central tube 36. In the fully retracted position shown in FIG. 2, the support element 86 is positioned immediately forward of a distal end of the linear actuator 40. The support element 86 includes vertical side walls 88 and a horizontal top wall 90 supporting one or more slide pads 92 formed of a low-friction material and configured to slidably support the inner tube 38. Because the support element 86 is fixed to the central tube 36, it moves together with the central tube 36 during extension and retraction. As shown in FIG. 7, the support element 86 is connected to the sledge 70 by longitudinal struts 96.

The outer tube 34 encloses the side walls 58, the bottom wall 62, and the top wall 60 of the central tube 36. The bottom wall 62 of the central tube 36 is supported on a bottom surface of the outer tube 34 by low-friction support pads (not shown) and, at a distal end, by rollers 94 supported on the outer tube 34. The pivot pins 52 and 46 permit limited vertical movement of the central tube 36 relative to the outer tube 34 during extension and retraction. The inner tube 38 is supported at a forward end by the rollers 72 of the central tube 36 and by the support element 86, which in the retracted position is located immediately forward of the distal end of the linear actuator 40.

Movement of the central tube 36 during extension and retraction and driven by the linear actuator 40, is transmitted to the inner tube 38 by a chain 74 or rope. As shown in FIG. 5, a first end of the chain 74 is fixed to an upper distal end of the outer tube 34, extends around a roller 76 supported at an upper distal end of the central tube 36 and a roller 78 at an upper proximal end of the central tube 36, and has a second end fixed to a proximal end of the inner tube 38. In a similar manner, flexible hydraulic and/or electrical lines may be routed to the distal end of the inner tube 38 for actuators and/or sensors of the tool 22, entrained around a roller 80 at the proximal end of the central tube 36 and a roller 82 at the distal end of the outer tube 34. The described arrangement thus couples movement of the central tube 36 relative to the outer tube 34 to corresponding movement of the inner tube 38 relative to the central tube 36.

In operation, starting from the retracted position shown in FIG. 2, pressurized hydraulic fluid is supplied to a piston chamber of the linear actuator 40, causing the piston 54 and rod 84 to extend and thereby drive the central tube 36 in a distal direction of the boom assembly 20. Concurrently, the chain 74 or rope draws the inner tube 38 outward from the central tube 36. Retraction is achieved by pressurizing a rod chamber of the linear actuator 40, thereby retracting the central tube 36 and, via the chain 74 or rope, retracting the inner tube 38.

The telescoping boom assembly 20 is substantially self-contained within the outer tube 34, as the linear actuator 40 and the chain or rope mechanism for moving the inner tube 38 are located within the outer tube 34, with the exception of the roller 76 and portions of the chain 74 or rope extending beyond the distal end of the outer tube 34. Because the housing 42 of the linear actuator 40 is fixed relative to the outer tube 34, hydraulic lines need not be routed through the rod 84, thereby increasing structural robustness of the rod and permitting use of a linear actuator having an integrated position sensor within the rod 84 for sensing a position of the rod. Such position information may be used for automatic length control of the telescoping boom assembly 20.

It should be understood that the rollers 72 and 94 may be replaced by one or more slide pads, and that the slide pad or pads 92 may alternatively be replaced by one or more rollers.

What is claimed is:

1. A telescoping boom assembly comprising:
an outer tube;
a central tube slidably disposed within the outer tube;
an inner tube slidably disposed within the central tube;
a linear actuator having a housing positioned between the central tube and the inner tube, the housing coupled to the proximal end of the outer tube, the linear actuator further having a movable output element coupled to a central tube distal end of the central tube and configured to move the central tube relative to the outer tube; and
a coupling mechanism operatively connecting the central tube to the inner tube and configured to move the inner tube relative to the central tube in response to movement of the central tube relative to the outer tube.

2. The telescoping boom assembly of claim 1, wherein the linear actuator comprises a double-acting hydraulic cylinder, and wherein the movable output element comprises a rod connected to the central tube.

3. The telescoping boom assembly of claim 1, wherein the inner tube is supported on the central tube by a support element positioned, in a longitudinal direction of the boom assembly, between the housing of the linear actuator and a boom assembly distal end, the support element affixed to and movable with the central tube.

4. The telescoping boom assembly of claim 3, wherein the support element comprises lateral side walls and an upper transverse wall, and wherein the inner tube is supported on the upper transverse wall by one or more slide pads.

5. The telescoping boom assembly of claim 1 further comprising:
a sledge slidably supported at the central tube distal end, the sledge configured to support the inner tube.

6. The telescoping boom assembly of claim 5, wherein the sledge is connected to the support element by one or more longitudinal struts.

7. The telescoping boom assembly of claim 5, wherein the housing of the linear actuator is coupled to the proximal end of the outer tube by a first pin, and wherein the movable output element of the linear actuator is coupled to the sledge by a second pin.

8. The telescoping boom assembly of claim 5, wherein the sledge supports an inner tube distal end on one or more rollers.

9. The telescoping boom assembly of claim 1, wherein the coupling mechanism comprises one or more of chain and a rope having a first end fixed to an outer tube distal end and a second end fixed to the inner tube, the chain and rope entrained around one or more rollers mounted on the central tube.

10. A vehicle comprising:
a chassis;
a ground-engaging member supporting the chassis;
a crane coupled to the chassis;
a telescoping boom assembly having a proximal end coupled to the crane and a distal end coupled to a tool, wherein the telescoping boom assembly includes
an outer tube;
a central tube slidably disposed within the outer tube;
an inner tube slidably disposed within the central tube;
a linear actuator having a housing positioned between the central tube and the inner tube, the housing coupled to the proximal end of the outer tube, the linear actuator further having a movable output element coupled to a central tube distal end and configured to move the central tube relative to the outer tube; and
a coupling mechanism operatively connecting the central tube to the inner tube and configured to move the inner tube relative to the central tube in response to movement of the central tube relative to the outer tube.

11. The vehicle of claim 10, wherein the linear actuator comprises a double-acting hydraulic cylinder, and wherein the movable output element comprises a rod connected to the central tube.

12. The vehicle of claim 10, wherein the inner tube is supported on the central tube by a support element positioned, in a longitudinal direction of the boom assembly, between the housing of the linear actuator and the distal end of the boom assembly, the support element affixed to and movable with the central tube.

13. The vehicle of claim 12, wherein the support element comprises lateral side walls and an upper transverse wall, and wherein the inner tube is supported on the upper transverse wall by one or more slide pads.

14. The vehicle of claim 10 further comprising:
a sledge slidably supported at the central tube distal end, the sledge configured to support the inner tube.

15. The vehicle of claim 14, wherein the sledge is connected to the support element by one or more longitudinal struts.

16. The vehicle of claim 14, wherein the housing of the linear actuator is coupled to the proximal end of the outer tube by a first pin, and wherein the movable output element of the linear actuator is coupled to the sledge by a second pin.

17. The vehicle of claim 16, wherein the sledge supports an inner tube distal end on one or more rollers.

18. The vehicle of claim 10, wherein the coupling mechanism comprises one or more of a chain and rope having a first end fixed to an outer tube distal and a second end fixed to the inner tube, the chain and rope entrained around one or more rollers mounted on the central tube.

19. The vehicle of 10 comprising one of forwarder and a harvester.
